(19) United States
(12) Patent Application Publication
(10) Pub. No.: US 2023/0189782 A1
(43) Pub. Date: Jun. 22, 2023

(54) METHOD AND APPARATUS FOR CONTROLLING PLANT INFECTIOUS DISEASES BY ATOMIZING CLAY MINERAL SUSPENDED WATER

(71) Applicant: TOSANOKI CO., LTD., Tosa-shi, Kochi (JP)

(72) Inventor: Osamu IZAWA, Tosa-shi, Kochi (JP)

(21) Appl. No.: 18/004,038

(22) PCT Filed: May 15, 2022
(86) PCT No.: PCT/JP2022/020298

§ 371 Date: Dec. 30, 2022

(30) Foreign Application Priority Data
May 17, 2021 (JP) 2021-083035

(51) Int. Cl. A01M 7/00; B01J 20/12; B01J 20/28; B01J 47/014; A01G 9/24; B05B 7/00; B05B 7/24

(52) U.S. Cl. CPC A01M 7/0003; B01J 20/12; B01J 20/28019; B01J 20/28004; B01J 47/014; A01G 9/246; B05B 7/0075; B05B 7/2494

(57) ABSTRACT

The problem to be solved is to deal with infectious diseases caused by pathogens that invade from the outside with ventilation to the cultivation room and adhere to the leaf surface or float in the cultivation room.

A silicate clay ore is powdered, and the powdered clay ore is mixed with water and stirred to prepare suspension water or its supernatant water. The present invention proposes a method of atomizing into a cultivation room using an atomizer capable of generating an air flow having a predetermined momentum.

### CROSS REFERENCE TO RELATED APPLICATIONS

This application is a national stage application, filed under 35 U.S.C. § 371, of International Application No. PCT/JP2022/020298, filed May 15, 2022, which claims priority to Japanese Application No. 2021-083035, filed May 17, 2021; the contents of both of which as are hereby incorporated by reference in their entireties.

### BACKGROUND

### Technical Field

The present invention relates to measures against infectious diseases of agricultural plants in a cultivation room.

### Description of Related Art

Various chemically synthesized pesticides are used as a countermeasure against infectious diseases caused by plant pathogens and the like. However, in recent years, attention has been paid to cultivation methods that do not use chemical pesticides such as biological pesticides from the viewpoint of side effects and health hazards of chemically synthesized pesticides. Clay minerals are an important element as clay components contained in a certain proportion of the constituent substances of soil. In addition to this, there are inventions that utilize the ion exchange and adsorptive properties of layered silicate minerals to fix ammonium ions in soil, bacteriostatic, and sterilize.

Clay minerals are used for soil improvement, crop activators, freshness preservation, environmental purification agents, etc., and bentonite as a pesticide carrier is widely used.

Regarding measures against infectious diseases of agricultural plants, there is a proposal for suppressing the growth of harmful bacteria by adding a lump of zeolite or silicic acid clay into a culture solution in hydroponics (JP S49-069433 A). Similarly, there is a proposal for suppressing the onset of disease caused by disease-causing bacteria by immersing seeds and seed potatoes in an aqueous solution of a zeolite or silicate clay powder (JP S62-061904 A). Treatment with water containing clay minerals to remove attached fungi of fresh vegetables and fruits (JP 2008-79579 A), keeping freshness of grains or beans, and treatment with water containing clay minerals to eradicate bacteria (JP 2009-00007 A) has been proposed.

In addition, there is an invention (JP 2001-95382 A) for measures against continuous cropping obstacles utilizing the adsorptivity and ion exchange property of clay mineral particles in the agricultural field. Further, in order to control pests that damage the fruits of plants, a method has been proposed in which a solvent containing water is added to a layered silicate mineral and applied to the surface of the fruits (JP 2020-176059 A). With respect to the atomizer according to the present invention, the applicant has proposed an atomizer capable of efficiently atomizing droplets and injecting an air jet having a predetermined momentum (JP 5517139, JP 6457720).

There have been many proposals to use clay mineral particles for roots and fruits themselves as a measure against infectious diseases and rot prevention of plants. However, there are few examples of using clay minerals as a countermeasure against infectious diseases in agricultural cultivation rooms. In the cultivation room, pathogens that invaded the room during ventilation adhere to the leaf surface and break the epidermal cells and cell walls, or invade through the wounds and stomata of the epidermal cells and break the cell nuclei, causing infectious diseases. On the other hand, there are many cases where agricultural sprayers are used for spraying chemicals and irrigation, but the adhesion of mist to the leaf surface also causes wetting and mold.

### BRIEF SUMMARY

One problem to be solved is to deal with infectious diseases caused by pathogens that invade from the outside with ventilation to the cultivation room and adhere to the leaf surface or float in the cultivation room.

Disclosed are devices and methods of atomizing clay mineral suspended water by an air flow in a cultivation room.

Ore containing clay minerals is powdered, mixed with water and suspended. Even when the powder does not reach a sufficient small particle size, it is possible to use the supernatant water in a state where it has been left for a certain period of time or longer at a predetermined concentration by utilizing the classification with water. One proposal is a method of atomizing droplets having a liquid phase/gas phase of 20% or less in terms of mass ratio and an average droplet size of 50 μm or less.

When clay ore is powdered, mixed with water and stirred, it is separated into charged clay particles and becomes clay suspended water containing charged clay particles. Even if the clay ore cannot be made into a sufficiently small powder, the clay suspended water where the clay ore is crushed, mixed with water and stirred is suspended in the state of clay ore immediately after suspension. But after being left for a certain period of time, the clay ore for sedimentation and charged clay particles separated from the ore appear. The supernatant of such suspended water contains a mixture of fine-grained clay ore with extremely slow sedimentation and clay minerals in the molecular state. In this suspended water, unique properties derived from the crystal structure and chemical composition of clay mineral molecules are exhibited. Clay mineral molecules become colloidal and disperse and aggregate. The layered structure of the clay particles is charged and has ion exchange properties. It is known that various substances including water are adsorbed in relation to water molecules between layers due to this ion exchange property and layer structure (see Gihodo Shuppan Co., Ltd. “Handbook of Clay and Minerals 3rd Edition” Editor The Clay Science Society of Japan (“Handbook”), p4 to p6).

Many of the pathogens that cause plant infections are surface charged. It is considered that the activity of these pathogens is restricted in the clay mineral supernatant by ion exchange or by the adsorptivity of the clay particles. However, simply immersing the clay ore in water has a low concentration of clay particles in the water, and a large effect cannot be expected. On the other hand, the water in the air jet is made into fine droplets by the kinetic energy of the jet, and when sprayed in an atmosphere less than the saturated water vapor pressure, the water component can be rapidly evaporated from the surface of the droplet to the air.

Utilizing the above, when the suspended water of clay ore powder or the supernatant water thereof is sprayed, the concentration of clay mineral particles can rapidly increase due to the evaporation of water. In particular, in a gas-liquid multiphase flow having a large initial velocity using a two-fluid atomizer, the phenomenon is remarkable, and a large increase in concentration occurs in an extremely short time. The fine droplets with increased clay particle concentration are mixed with the infectious disease pathogen itself floating in the air and water droplets carrying the pathogen. And we think that clay mineral particles constrain its activity of pathogens. Some have argued that clay particles stimulate plant growth due to the above-mentioned characteristics, increasing resistance to infectious diseases.

### BRIEF DESCRIPTION OF THE FIGURES

FIG. 1 is a graph showing clay weight and residual ratio in clay ore powder suspension water (execution example 1)

FIG. 2 is a particle size distribution diagram of clay ore powder (average 6.98 μm).

FIG. 3 is a particle size distribution diagram of clay ore powder (average 2.87 μm).

FIG. 4 is an explanatory diagram of various two-fluid injection valves.

FIG. 5 is an explanatory diagram showing the overall configuration of the atomizer (Example 1).

FIG. 6 is a detailed structural view of a two-fluid injection valve of an atomizer (Example 1).

### DETAILED DESCRIPTION OF VARIOUS EMBODIMENTS

In the present description, a mineral means an inorganic substance existing in the crust and can be represented by a certain chemical formula, an ore means a rock containing the mineral, and a clay ore means an ore containing a large amount of clay. Further, clay generally refers to soil particles smaller than a certain particle size constituting soil, but in the present invention, it refers to minerals or mineral particles made of silicate minerals having a layered structure. The crystal structure of the layered structure of this silicate mineral is based on a tetrahedron structure in which Si⁴⁺ is surrounded by four O²⁻. A tetrahedron sheet is formed by sharing three of the four vertices of this tetrahedron with adjacent tetrahedra. On the other hand, there is an octahedral sheet centered on Al³⁺ and the like, and it is a sheet that shares four points except for the two opposite vertices of the octahedron surrounded by six O²⁻ or (OH)⁻. Various clay minerals are formed by the combination of these tetrahedral sheets and octahedral sheets. The clay ore used in the examples of the present description contains a large amount of smectite-based clay minerals, and has the composition of Table 1. The smectite-based clay mineral has a layered structure in which the above-mentioned octahedral sheet is sandwiched between two the tetrahedral sheet. Therefore, it is called a 2:1 layer. It is said that there are water molecules between the layers and metal positive ions are present and balanced with the negative charge on the layer surface (for the contents other than those related to Table 1, refer to Handbook, p21 to p27 and p65 to p67). Regarding smectite-based clay minerals used in this specification, “In 1955, the nomenclature committee of the British Clay Minerals Group decided to adopt smectite for mineral groups that were previously called montmorillonite genus, montmorinoid, etc., and this name has taken root.” (Refer to lines 7 to 10 of Handbook, p65) was received.

TABLE 1
Composition table of smectite-based ore of the example

| | |
|---|---|
| Silica(Silicon dioxide, SiO₂) | 72.96% |
| Aluminium oxide (Al₂O₃) | 9.92% |
| Sodium oxide | 4.98% |
| Iron oxide (Fe²O³) | 4.95% |
| Calcium oxide | 3.27% |
| Potassium oxide | 0.13% |
| Moisture(H₂O) | 3.81% |

In the state produced as an ore, minerals other than clay minerals (hereinafter, also referred to as impurities in the present description) are contained, and at the same time, the clay minerals are folded in a complicated and dense state, and the properties of clay mineral do not appear. The above-mentioned unique properties of clay are manifested by mixing with water or suspending in water. The conventional inventions described in the above “0005” to “0006” also utilize the characteristics of such clay minerals. Although extremely fine nano-level clay particles exist in a colloidal state in water, they can be repeatedly dispersed and aggregated due to the influence of gravity, Brownian motion, and the above-mentioned electrical characteristics and intermolecular force. Even in still water, the clay particle colloid is extremely difficult to settle and is floating, but it is considered that some of the clay particle colloids aggregate to form flocs and settle as the amount of clay particles increases.

In the present invention, various methods are taken in order to utilize the above-mentioned characteristics of the clay particles. As a premise, ore containing a large amount of layered silicate minerals is used. The following procedure is followed as a method for increasing the purity of the target clay mineral from the state of the ore and utilizing the suspended water containing as much colloidal clay particles as possible separated from the ore.

As a first step, clay ore is powdered by a crusher to prepare a powder having a fine particle size. In this description of embodiments, a powder having an average of about 7 μm and being further classified with water will be described in detail. In addition, in this description, classification with water means that ore is screened by the difference in the sedimentation speed in water. As a second step, the powder is mixed with water and stirred to prepare suspended water. If it is necessary to classify with water, after suspension, make it still water, settle and classify clay ore and impurities with large particle size, and collect the supernatant water. The supernatant water in the present invention is suspended water of clay particles, and means that clay ore not separated into clay particles and impurities are removed from the suspended water. Therefore, when clay ore with few impurities is made into a fine powder that can be easily separated into clay particles in water, it is able to be used as it is as suspended water in the next third step by mixing and stirring with water.

As a third step, the suspended water obtained in the second step is made into droplets by an air jet. The droplets evaporate water in the cultivation room and further atomize to increase the concentration.

In the first step, the particle size distribution of the powder having an average of about 7 μm of the ores of the components in Table 1 is shown in FIG. 2. The bar graph is the probability distribution, and the line connecting the round points is the cumulative distribution. This is due to the particle size distribution measuring machine by the laser diffraction/scattering method. In the present description, the powder, particles, fine particles and fine droplets refer to a solid or liquid having a diameter of about 100 μm or less.

The powder of this clay ore is stirred in water, suspended, and the state of the supernatant liquid after several hours, in the second step, will be described. As a basic idea of the sedimentation method for measuring the particle size of particles, there is Stokes' equation of Math. 1 for obtaining the sedimentation rate when each sample in water is assumed to be a sphere. It is obtained from the rate of subsidence due to the difference in density between the sample and water. It is a basic formula for classification by water.

vₛ=(ρₛ−ρ)×d²×g/(18*μ) [Math. 1]

vₛ: Final subsidence velocity in water m/s

ρₛ: Unit volume mass of sediment kg/m³

ρ: Unit volume mass of water kg/m³

d: Diameter of sediment m

g: Gravitational acceleration 9.8 m/s²

μ: Viscosity coefficient of water Pa*s

According to this formula, if the density of the ore is 2.65 g/cm³, the density of water is 1.0 g/cm³, and the viscosity coefficient of water at a temperature of 20° C. is 1.004×10⁻³ Pa sec, it takes 8 hours later, in the supernatant of 10 cm from the surface layer, the ore having a particle size of 2 μm or more is removed. According to FIG. 2, the sample having a particle size of less than 2 μm accounts for about 8% of the whole. It is not possible to quantitatively evaluate the particle size measurement by the laser diffraction/scattering method and the particle size estimation by Stokes' law from the same viewpoint. However, according to the above-mentioned Stokes' law, it is clear that the suspended solids in the supernatant water of the suspended water have a constant ratio of the suspended solids having a particle size of a certain particle size or less in the cumulative distribution of FIG. 2.

The supernatant water in Example 1 is obtained by suspending powdered clay ore in water for about 2 days (48 hours) and then taking water, but the supernatant range is a layer about 60 cm from the water surface (surface layer). Therefore, it is assumed that the supernatant water in Example 1 will be almost the same as the supernatant water of 10 cm in 8 hours of the formula 1. Further, in Examples 2, Example 3 and Example 4, the supernatant water is used 12 hours after suspension, but since it is collected from a layer about 15 cm from the water surface, it is assumed to be equivalent suspended water.

In the example of the present description, after suspending the clay ore powder of Table 1 at a weight ratio of 1/500 to 1/20000, the amount of silicon was measured for the suspended supernatant water after 2 days. The results are shown in Table 2. From the suspended water of each concentration, the total amount of silicon consisting of the amount of insoluble silicon and soluble silicon is measured by the method shown at the bottom of the table. In addition, the insolubility or solubility in this section or related sections refers to those detected by the methods described at the bottom of the table, and the solubility does not mean the amount of silicon dissolved in water in the ionic state. Regarding silicon in the solvent in Table 2, it seems that silicon was detected because a glass beaker was used in the experiment. Based on the amount of silicon measured in Table 2 minus the amount of silicon in the solvent, Table 1 was used to estimate and convert to clay components, as shown in Table 3 below. The suspended water of the ore used in the examples was calculated by the clay conversion method shown at the bottom of Table 3, assuming that the ore is an aggregate of clay particles without impurities.

TABLE 2
Measurement result of silicon mass in supernatant water

Silicon mass

| | Insoluble | Soluble | Total amount |
|---|---|---|---|
| Suspended solids ratio | Si(mg/L) | Si(mg/L) | Si(mg/L) |
| Solvent(Water) | 0.0 | 0.2 | 0.2 |
| 1/500 | 15.5 | 16.8 | 32.3 |
| 1/1000 | 11.0 | 16.3 | 27.3 |
| 1/5000 | 5.4 | 14.5 | 19.9 |
| 1/10000 | 3.9 | 14.4 | 18.3 |
| 1/20000 | 2.2 | 13.9 | 16.1 |

Measuring Method
Step 1. To filter 250 mL of sample using filter paper (5A).
Step 2. To put the filtrate in a beaker and add HCl (5 mL), and decompose by heating acid on a hot plate.
Step 3.The filter paper is placed in a pre-weighed platinum crucible, heated in an electric furnace at 500° C. (2 hours), then ignited at 1050° C., weighed, and the amount of insoluble SiO₂ calculated and converted to the amount of Si.
Step 4. After acidolysis by heating, the filtrate is made up to 250 mL, diluted 10-fold, and the Si concentration in the solution is calculated by ICP emission spectrometry.
Step 5.The total Si content is calculated by summing the Si content in steps 3 and 4.

TABLE 3
Result of converting clay particles contained in supernatant water

| | Amount of suspended clay | | | |
|---|---|---|---|---|
| | | | Total | Residual ratio |
| Amount of clay | Insoluble clay | Soluble clay | amount clay | in supernatant |
| when mixed | particles(mg/L) | particles(mg/L) | particles(mg/L) | water |
| 1/500 (2000 mg) | 45.4 | 48.7 | 94.1 | 0.047 |
| 1/1000(1000 mg) | 32.3 | 47.2 | 79.5 | 0.079 |
| 1/5000(200 mg) | 15.8 | 41.9 | 57.8 | 0.289 |
| 1/10000(100 mg) | 11.4 | 41.6 | 53.1 | 0.531 |
| 1/20000(50 mg) | 6.5 | 40.2 | 46.6 | 0.932 |

The atomic weight of silicon is 28.09, the atomic weight of oxygen is 16.00, and the molecular weight of silicon oxide (silica) SiO₂ is 60.09.
Based on these, the clay particle conversion value was calculated from the clay ore composition table of Table 1 for the silicon content of Table 2.

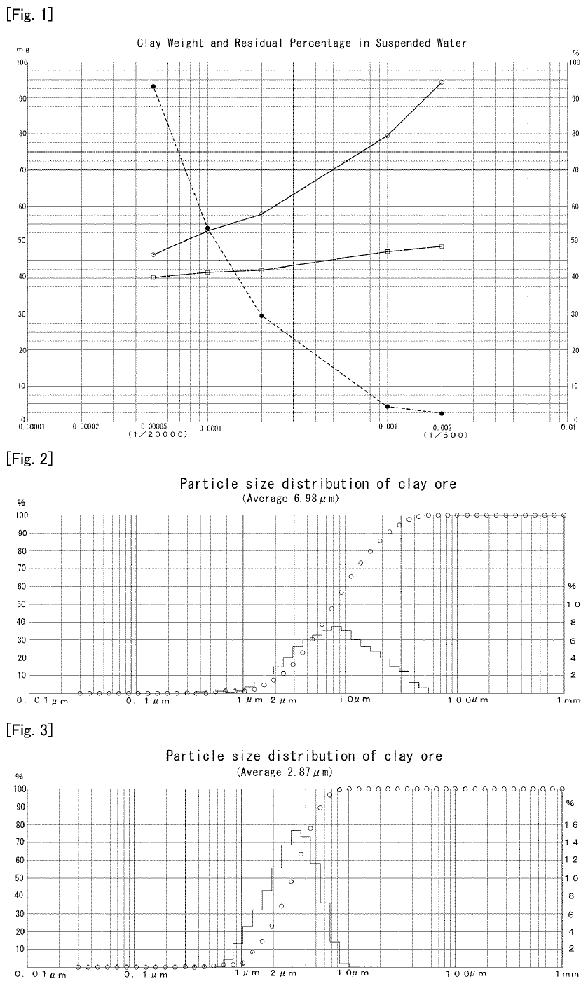

FIG. 1 shows the converted clay component amount in Table 3 as a semi-logarithmic graph. What is shown in the left vertical direction is the weight of suspended clay, the circle display is the total clay weight conversion value, and the square display is the clay particle weight conversion value of silicon in solution. (Hereinafter, the expression of “converted value” is omitted with respect to the numerical values related to Table 3.) On the other hand, what is displayed in the right vertical direction is the ratio of the weight of clay particles remaining in the supernatant suspended water to the weight of clay at the time of suspension, and is indicated by a black circle. When clay ore with the same particle size distribution is suspended and mixed in water under the same conditions, if there is no change in the state in the suspended water, the residual clay will remain regardless of the concentration at the time of mixing the suspension. It is Stokes' law that the weight ratio must be constant.

Regarding the residual clay weight obtained in the experiment, the result is different from that of Stokes' law shown in “0020”. According to the results obtained in this experiment, the weight ratio of the residual clay varies greatly depending on the concentration at the time of mixing and suspension. The weight of clay remaining in the suspended supernatant water at a weight ratio of 1/500 to 1/20000 is about 5% to 93% as a ratio to the total amount at the time of suspension. When the concentration at the time of suspension decreases, the residual clay weight ratio has increased significantly (black circles and dashed lines in FIG. 1). In the supernatant water of 1/500 of the suspended water having a high concentration at the time of suspension, the clay component remaining in the supernatant water is about 5%, and the weight ratio with the final water is 1/10000. In the supernatant water of 1/1000 suspended water, the clay component remaining in the supernatant water is about 8%, and the weight ratio with water is 1/12500. In the supernatant water of 1/5000 of the suspended water, the clay component remaining in the supernatant water is about 29%, and the weight ratio with the water is 1/17200. In the supernatant water of 1/10000 suspended water, the clay component remaining in the supernatant water is about 53%, and the weight ratio with water is 1/18900. In the suspended water of 1/20000, which has the lowest concentration at the time of suspension, about 93% remains in the suspended water, and the weight ratio with water is 1/21500.

The above-mentioned Stokes' equation expresses a sedimentation phenomenon due to a density difference with water in an ore state, and the calculation result in Table 3 shows that after suspension, the clay ore is separated into the clay particles described in “0014”. Therefore, after suspending and mixing the above clay ore with water, the sediment that did not remain in the supernatant water was settled with ore of approximately 2 μm or more in terms of sphere, other impurities, and clay particles forming large flocs. It is considered that, in the supernatant water, there are clay in the ore state of less than 2 μm in terms of sphere, colloidal clay particles separated from the ore, and relatively small-scale floc clay particles, and the size is 7 μm or more. This is because even a floc having a size of 7 μm or more does not settle when the density is low. (Note that the reserved particle size of the filter paper of 5A is 7 μm, and as shown in Table 3, there are soil particles that do not penetrate the filter paper.) The separation of clay particles from the ore state seems to be related to the concentration of clay particles in the water. Most of the ore is separated into clay particle state in the state of low substance concentration at the time of suspension such as supernatant water collected in 1/20000 suspension water. The above indicates that the ore in Table 1 has very few impurities. On the other hand, if the suspended ore is less than about 2 μm in terms of sphere, it is presumed that it can be easily made into a clay particle state by sufficient mixing.

According to the results of this experiment, the supernatant water having a concentration of 1/20000 or less at the time of suspension can efficiently obtain a spray liquid in a state close to that of clay particle colloid, but the concentration is low. On the other hand, when suspended water of 1/500 or more is used, a high concentration of supernatant water can be obtained, but the efficiency of the available clay mineral amount is extremely low.

It is presumed that the larger the surface area of the clay mineral having a layered structure, the more remarkable the ion exchange property and the adsorptive property. Considering this, in order for the clay particles floating in water or air to function most effectively as a countermeasure against infectious diseases, clay particles alone, relatively small-scale clay particle flocs, or clay particle flocs that are easily dispersed, need to be present in high concentrations.

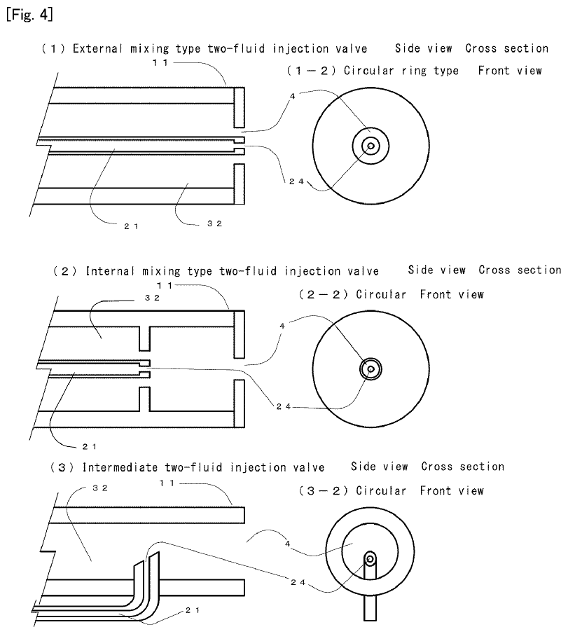

The graph of FIG. 3 shows a powder of clay ore as the component of Table 1 with an average of 2.87 μm. This was made finer than the powder shown in FIG. 2. Even in the suspended water of this powder, sediments are visually recognized in the suspended water, and unseparated components into clay particles are observed. In this powder ore, there is about 77% of powder of 2 μm or more by the particle size distribution measuring machine by the laser diffraction/scattering method. To shorten the supernatant time of the suspended water and to use the suspended water as it is, it is necessary to devise further atomization of clay ore or stirring/mixing with water for efficient separation into clay particles.

In the third step, the suspended water or its supernatant water obtained in the second step is dropletized by an air jet, and the water corresponding to the solvent contained in the droplets is evaporated into the air as water vapor to increase the clay particle concentration. The purpose is to make droplets of extremely high concentration. When further evaporated completely, the clay particles can separate from the water covering the surface and create a state of floating in the air.

The main object of use of the atomizer in the present invention is not irrigation that can be placed in the cultivation room. Clay mineral suspended water or its supernatant is dropletized and further atomized, and the clay particle components are distributed throughout the cultivation room as much as possible. Basically, the mass ratio of the liquid phase to the gas phase is set to 0.2 at the maximum. (This mass ratio is also hereinafter referred to as jet mass ratio in the present invention.) However, as shown in the examples (“0044” below), when the humidity in the cultivation room is low, the operation also for the purpose of irrigation can be performed. In the atomizer of the present invention, the portion that injects an air jet containing a liquid is called a two-fluid injection valve. In the cultivation room, there are two types of gases, jet air containing droplets from the two-fluid injection valve and air in the cultivation room around the jet. For convenience, they are referred to as the jet body and the surrounding air. If the causative substance of the infectious disease is present in the cultivation room, the causative substance has an opportunity to come into contact with the clay mineral suspended water at the stage when the suspended water of the clay mineral is made into droplets as the jet body or at the stage when the jet body entrains the surrounding air.

The characteristics of the atomizer are the particle size of the droplet atomized, the reach distance of the droplet, the atomizing angle, and the atomizing pattern. From the above-mentioned purpose of use of the atomizer in the present invention, it is desirable that the droplet size is as small as possible, the reach distance should be such that it covers the entire cultivation room. The atomizing angle is desirable to go upward to take into account the large number of stomata on the underside of the leaves and to increase the residence time of the droplets. And it is necessary to set the atomizing pattern considering the humidity environment in the cultivation room. The droplet size is related to the injection hole and discharge hole shape, the atomizing pressure, and the jet mass ratio of the two-fluid injection valve of the atomizer. In the present description, the droplet size is measured by irradiating a laser beam, and the average droplet size is the Sauter mean diameter.

The air jet ejected from the two-fluid injection valve entrains the surrounding air and flows while mixing with the droplets, except in the immediate vicinity of the injection hole. Considering the increase in the concentration of colloidal clay particles in water and floating in the air, this jet has the kinetic energy required to dropletize the discharged liquid and further atomize it. And the momentum required to obtain a predetermined reach distance. Therefore, this jet has a high Reynolds number and is a so-called turbulent jet. Regarding the axially symmetrical circular jet of turbulent flow, the following flow characteristics have been proposed as theoretical values and verified with experimental values (Toshihiko Kawauchi, “Jet Flow Engineering-Basics and Applications-” MORIKITA PUBLISHING CO., LTD. 2013, p30-p34).

As a two-fluid injection valve in which the liquid efficiently receives the kinetic energy of the gas, a structure in which the gas injection hole is arranged so as to surround the liquid discharge hole is suitable. Regarding the structure of such a two-fluid injection valve, there are three types: a type that mixes outside the valve, a type that mixes inside, and an intermediate type. They are shown in FIG. 4. In the Example of this embodiment, an intermediate type shown in FIG. 4(3) is adopted. In addition, the following can be said about the evaporation amount that governs the droplet radius and the clay particle concentration of the droplet.

$$\text{?} \\ \text{?} \text{indicates text missing or illegible when filed} \qquad [ Math . 3 ]$$

About the relationship between evaporation and radius of droplet
Volume of droplet of radius r: 4/3×π×r³
Evaporation amount when evaporating from the droplet surface to the thickness of t: 4×π×r²×t
(Since t<<r, ignoring the squared and cubic terms of t)
For a droplet of radius (1/n)×r,
Evaporation of a droplet of radius (1/n)×r: 4×π×(r/n)²×t=(1/n²)×4×π×r²×t
The number of droplets of radius (1/n)×r that have the same volume as one droplet of radius r: n³ [symbol]
Evaporation of entire droplet group with radius (1/n)×r: n³×(1/n²)×4×π×r²×t=n×4×π×r²×t
Under the same conditions,
the amount of evaporation increases in inverse proportion to the droplet radius.

The formation of droplets and the refining of the size of the droplets by the atomizer depend on the shape of the two-fluid injection valve, the flow rate of the air flow, and the size of the injection hole. Atomization after formation of droplets is caused by the evaporation of water from the surface of the droplets, which is related to the humidity and temperature of the surrounding air, the relative speed with respect to the surrounding air, and the like. This evaporation of water increases the concentration of the clay particle component in the droplet. The creation of small radius droplets is governed by the surface tension of the water and the transfer of the kinetic energy of the air jet by the atomizer's two-fluid injector to the suspension. Evaporation of water in subsequent droplets is then strongly related to the radius of the initial droplet produced. From Math. 3, it can be understood that the amount of droplet evaporation increases in inverse proportion to the droplet radius under the same conditions. Furthermore, Proceedings of the Kinki Branch of the The Society of Heating, Air-Conditioning and Sanitary Engineers of Japan “Fundamental Study on Behavior Analysis of Droplet Sprayed in Air” and “Same Name (Part 2)” Toshio YAMANAKA, Kazunobu SAGARA et al. 3 others 2010 and 2011 can be cited as an analysis using a heat balance equation with the surrounding air, a mass conservation equation, and an equation of motion for a more specific droplet evaporation amount. As a result of analysis by this Literature, “Figure 7 Behavior of Droplet from Numerical Analysis (a) Radius of Droplet” show the analysis results for droplets with five different radii from 10 μm to 100 μm under the conditions of temperature 20° C., initial horizontal velocity 10 m/s, and relative humidity 50%. At a radius of 25 μm or less, the droplet disappears in several seconds, and at a radius of 10 μm, it takes about 1 second.

### EXAMPLE 1

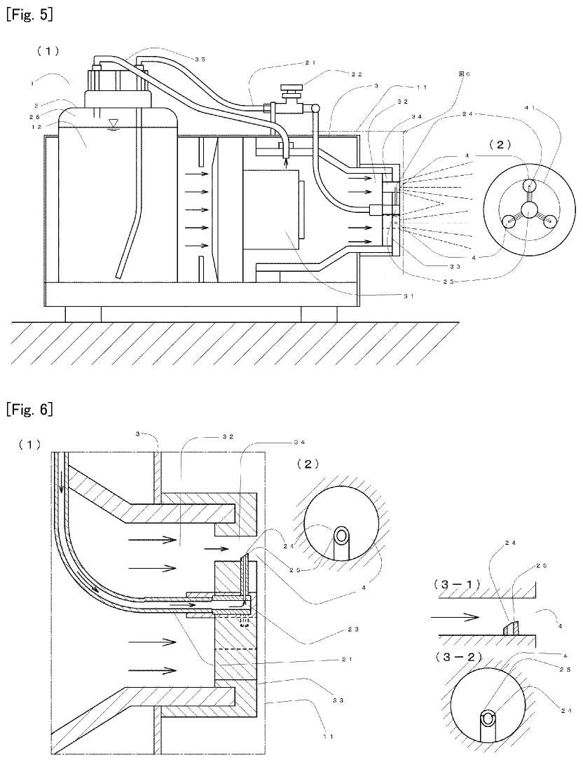

FIG. 5(1) shows the internal structure of the atomizer 1 in cross-sectional view from the side as Example 1. The atomizer comprises a pressurized liquid tank 2, a casing 3, and an air blower 31 placed at one end of the casing. An Air passing section 32 having a smaller diameter than the inner diameter of the casing fixed to the other end of the casing is formed in the atomizing direction. Furthermore, an ejection head 33 is provided at the tip of the other end, and an air ejection hole 4 is provided at the downstream end of the ejection head. The pressurized liquid tank contains supernatant water of suspension of powdered clay ore having the composition of Table 1, which is about 7 μm on average as shown in FIG. 2. The suspension water has a clay ore (powder)/water weight ratio of 1/500 to 1/20000, and the supernatant water is obtained by allowing the suspension water to stand still for two days. A pipe 35 for sending air to the upper part of the pressurized liquid tank is provided to connect the air section 26 in the upper part of the pressurized liquid tank and the inside of the casing or the air passing section through which the air flow flows, and has the role of pressurizing the liquid tank. At the ejection head on the other end side of the casing, the ejection head is divided into three air passing part of the ejection head 34 having smaller diameters than the air passing section, and communicates with the air ejection hole 4. A front view of the structure of the air ejection hole is shown in FIG. 5(2). FIG. 6(1) shows an enlarged detailed view of the two-fluid injection valve 11 of the atomizer. A liquid feed pipe 21 extending from the pressurized liquid tank branches through a liquid feed branch 23 into three liquid discharge holes 24 provided in the three air passing part of an ejection head. The liquid discharge hole is arranged so that the spouting direction has a predetermined angle (90 degrees in this Example) with respect to the airflow from the blower in the air passing part of the ejection head. An enlarged view of the air passing part of the ejection head viewed from the upstream direction is shown in FIG. 6(2). A liquid discharge hole tip surface 25 facing the airflow in the air passing part of an ejection head is formed. FIGS. 6(3-1) and 6(3-2) show an example in which the tip surface is formed from two surfaces. The liquid discharge hole tip surface has the effect of thinly stretching the discharge liquid (suspended water) along the air current in the air passing part, and effects the fineness and atomization of droplets of the discharge liquid. An inclination angle against the airflow is desirable 30 degrees to 45 degrees (reference JP 5517139 and JP 6457720, however, there are changes in the names of the elements that make up the atomizer).

In the atomizer 1 of this example, the airflow from the air blower 31 passes through the air passing section 32. And the airflow is divided into three passages under the same conditions by the ejection head 33. The air passing part of the ejection head 34 are passages through which the divided airflow passes. Therefore, it is the name given to a part of the air passing section. When the three ejection holes 4 shown in FIG. 5(2) have a diameter of 8.5 mm and predetermined blower and power supply are installed, an air flow of 20 g/sec can be ejected and the flow velocity is about 100 m/sec. In this example, the three injection holes are arranged within a 40 mm circumscribed circle 41, interfere with each other or are related to each other, integrate near the ejection holes, and then behave as one jet. Therefore, using Math 4 below, analysis is performed as an axially symmetrical circular jet. Table 4 shows the flow conditions at positions downstream from the air ejection holes for this virtual axially symmetrical circular jet, using the jet characteristics of Math 2.
Unit time flow volume of three ejection holes: Q₁˜Q₃
Flow velocity of three ejection holes U₁˜U₃
Diameter of three ejection holes : D₁˜D₃
Assuming a jet flow from one virtual ejection hole,
Unit time flow volume: Q, flow velocity: U, diameter: D

ρ×(Q₁×U₁+Q₂×U₂+Q₃×U₃)=ρ×Q×U

π/4×ρ×(D₁²×U₁²+D₂²×U₂²+D₃²×U₃²)=π/4×ρ×D²×U²
Here, since D₁˜D₃=D₁, U₁˜U₃=U₁,

D×U=√(3×D₁²×U₁²)=√3×D₁×U₁

Re=√3×D₁×U₁/ν [Math. 4]

TABLE 4
State of the jet downstream from the ejection hole (Example 1)

| | Maximum | Velocity | Volume |
|---|---|---|---|
| Distance | flow velocity | half width | flow rate |
| (x) (m) | (m/sec) | (m) | (m³/sec) |
| 0 | 100 | — | 0.017 |
| 1 | 8.82 | 0.086 | 0.371 |
| 2 | 4.41 | 0.172 | 0.741 |
| 4 | 2.205 | 0.344 | 1.482 |
| 10 | 0.882 | 0.86 | 3.706 |
| 20 | 0.441 | 1.72 | 7.412 |

Based on the study of Math 4, Table 4 shows the flow condition calculated on Math 2 as a turbulent, axially symmetrical circular jet from one air ejection hole of 14.72 mm for three air ejection holes of 8.5 mm in diameter. With respect to the initial velocity of 100 m/sec, the maximum flow velocity at the center of the jet of 1 m downstream drops rapidly to 8.82 m/sec. However, the volume flow rate is 21.8 times the initial value. It shows that the surrounding air is involved. In such a state, the droplets in the turbulent jet are presumed to be in vortices of various sizes in the jet body and the surrounding air, have relative velocities on average, and are contact with the air around the droplets. At 10 m downstream, the maximum flow velocity is 0.882 m/sec. When the maximum flow velocity of the jet flow at each point is calculated, it is 6 seconds or less for the flow time of the droplet within 10 m from the ejection hole. That is, if the droplet floats at the maximum flow velocity, it will reach the position of 10 m in about 6 seconds. Considering the consideration of “0037”, the average particle size (diameter) required for droplets in the vicinity of the ejection hole is set to 50 μm, preferably 30 μm or less

As an example of discharging of droplets in Example 1, the air density is presumed 1.205 kg/m³, the mass ratio is set to 20%. For ejection of an air flow of 20 g/second the discharging liquid is set to about 4 g/second. The humidity of the surrounding air is 80%, and the particle size of the droplet is measured to be 30 μm in the Sauter mean particle size near the air ejection hole. Moreover, the atomizing distance by visual observation was 20 m. An atomizing distance of 20 m is understood to be a necessary distance for a normal cultivation room. In addition, regarding the atomizing distance by visual observation, it means that droplets remain without being evaporated at that distance. This is because the mass ratio is maximized and the relative humidity is high. In this case, the Reynolds number Re in Math 4 is about 97000 when the kinematic viscosity coefficient is presumed 1.512×10⁻⁵ m²/sec.

For suspended supernatant waters with clay ore/water weight ratios of 1/500 and 1/20000, the residual suspended clay weight (notation is total clay particles), as shown in Table 3 and as described “0027”, is about 2:1. Although, atomizing with an air/liquid mass ratio adjusted according to the humidity environment in the cultivation room can make the released clay particle weight into the cultivation room constant. For example, in a high humidity state, the suspended supernatant water with clay ore/water weight ratios of 1/500 is atomized at a jet mass ratio of 10% or less. In a low humidity state, the suspended supernatant water with clay ore/water weight ratios of 1/20000 is atomized at a mass ratio of 20% or more. Such is possible. On the other hand, it is possible to make the weight of the clay particles discharged into the cultivation room constant by adjusting the number of times of atomizing with the supernatant water having the same clay ore/water weight ratio.

As described above, it is possible to perform atomizing adjusted according to the humidity environment and the indoor environment of the cultivation room where infectious diseases occur, by adjusting the concentration (weight ratio) of the supernatant water, the number of times of atomizing, and the atomizing time.

### EXAMPLE 2

Cultivation room to be atomized: 4,000 m² (10,000 m³) in three houses for year-round shipping of cut roses.

Cultivation method: Soil cultivation

Atomizing liquid: Using the clay ore in Table 1 as powder having the particle size distribution in FIG. 2; the powder in a weight ratio of 1/500 was mixed with tap water and stirred to create a suspension; the suspended water was left to stand for 12 hours and then collected supernatant water.

Condition 1

Cultivation room: Basically closed (open at least once a day for ventilation).

Atomizing period: November to April.

Amount of atomization: 3-4 L/1000 m² (2500 m³) using the atomizer of Example 1.

Atomization method: Atomizing once in the evening on every 3-4 days (closed at night).

Condition 2

Cultivation room: Side opening

Atomizing period: May to October

Amount of atomization: 3-4 L/1000 m² (2500 m³) using the atomizer of Example 1.

Atomizing method: once to several times on every day (open all day).

Effect: Conventionally, chemical spraying was carried out as a countermeasure against infectious diseases such as black spot, branch wilt, powdery mildew, and damping-off, but one year of operation without using chemicals had the same effect as chemical spraying. With regard to damping-off disease, although it is a soil-derived infectious disease, it has the potential to be effective against infectious diseases other than the leaves and stems.

### EXAMPLE 3

Cultivation room to be atomized: 4,000 m² (10,000 m³) in three houses for strawberry cultivation.

Cultivation method: Soil cultivation.

Atomizing liquid: Using the clay ore in Table 1 as powder having the particle size distribution in FIG. 2; the powder in a weight ratio of 1/500 was mixed with tap water and stirred to create a suspension; the suspended water was left to stand for 12 hours and then collected supernatant water.

Condition 1

Cultivation room: Basically closed (open at least once a day for ventilation).

Atomizing period: November to April.

Amount of atomization: 3-4 L/1000 m² (2500 m³) using the atomizer of Example 1.

Atomization method: Atomizing once in the evening on every 3-4 days (closed at night).

Condition 2

Cultivation room: Side opening.

Atomizing period: May, June, October.

Amount of atomization: 3-4 L/1000 m² (2500 m³) using the atomizer of Example 1.

Atomizing method: once to several times on every day (open all day).

Effect: It was effective as a countermeasure against powdery mildew in condition 1 and against gray mold in conditions 1 and 2.

### EXAMPLE 4

Cultivation room to be atomized: 300 m² (750 m³) in one house for strawberry cultivation.

Cultivation method: Soil cultivation.

Atomizing liquid: Using the clay ore in Table 1 as powder having the particle size distribution in FIG. 2; the powder in a weight ratio of 1/500 was mixed with tap water and stirred to create a suspension; the suspended water was left to stand for 12 hours and then collected supernatant water.

Cultivation room: Open during the day, closed at night.

Atomizing period: February, March.

Amount of atomization: 0.5-0.6 L/300 m² (750 m³) using the atomizer of Example 1.

Atomization method: Atomizing once in the evening on every day (closed at night).

Effect: No mites, powdery mildew, or gray mold.

There was no need to perform conventional 2-3 times/month, 0.05-0.08 L/time disinfection.

For measuring leaf thickness:

Measured at 23 locations on 0.267 mm leaf thickness on January 31 before operation.

Measured at 46 locations with a leaf thickness of 0.303 mm on March 5 after operation.

Point of operation: Operate during the dry time immediately after the cultivation room is closed.

In this example, the leaf thickness was measured before and after the application in the cultivation room. The increase in leaf thickness is related to the thickness of epidermal cells and cell walls, and is related to the resistance to pathogenic fungi. The relationship between the increase in leaf thickness and the application of this example, and other factors related to the increase in leaf thickness, such as the influence of sunlight at the time of measurement and the growth process of plants, are unknown. This is an issue for the future. In this example, it is showed that subsequent harvests were possible without the need for any disinfection.

1-9. (canceled)

10. A method for a countermeasure against infectious diseases of plants in a cultivation room, comprising the steps of:
powdering a smectite-based clay ore into a powder comprising a spherical particle size of less than 2 μm;
mixing and stirring the powdered clay ore with water to form a suspended water; and
atomizing the suspended water with an air stream into droplets with an average diameter of 50 μm or less.

11. A method for a countermeasure against infectious diseases of plants in a cultivation room, comprising the steps of:
powdering a smectite-based clay ore into a powder comprising a particle size distribution of average 7 μm or less;
mixing and stirring the powdered clay ore with water to form a suspended water, the suspended water comprising a supernatant water;
collecting the supernatant water from the suspended water, wherein the suspended water has a weight ratio of the powdered clay ore and water between 1/10000 to 1/21500; and
atomizing the supernatant water with an air stream into droplets with an average diameter of 50 μm or less.

12. The method of claim 10, wherein the step of atomizing the suspended water with an air stream into droplets comprises forming droplets with an average diameter of 30 μm or less.

13. The method of claim 11, wherein the step of atomizing the supernatant water with an air stream into droplets comprises forming droplets with an average diameter of 30 μm or less.

14. The method of claim 10, wherein the step of atomizing the suspended water comprises forming a jet at 10% to 20% mass ratio of liquid phase to gas phase.

15. The method of claim 11, wherein the step of atomizing the supernatant water comprises forming a jet at 10% to 20% mass ratio of liquid phase to gas phase.

16. An atomizer for atomizing in a cultivation room comprising:
a pressurized liquid tank for containing the suspended water of claim 10;
a casing comprising an inner diameter;
an air blower placed at one end of the casing;
an air passing section comprising a smaller diameter than the inner diameter of the casing, connected to the other end of the casing in the atomizing direction;
a liquid discharge hole which is arranged in the air passing part so that the discharging direction has a predetermined angle with respect to a direction of airflow from the air blower;
a liquid feed pipe extending from the pressurized liquid tank to the liquid discharge hole; and
an air ejection hole connected to the air passing section.

17. The atomizer of claim 16, wherein the liquid discharge hole comprises a tip surface facing the airflow in the air passing section.

18. The atomizer of claim 16, wherein the atomizing direction from the air ejection hole is upward.
